(19) United States
(12) Patent Application Publication
(10) Pub. No.: US 2015/0348167 A1
(43) Pub. Date: Dec. 3, 2015

(54) Electronic Commerce Social Gifting

(71) Applicant: John Michael McDermott, Kings Beach, CA (US)

(72) Inventor: John Michael McDermott, Kings Beach, CA (US)

(21) Appl. No.: 14/613,098

(22) Filed: Feb. 3, 2015

Related U.S. Application Data
(60) Provisional application No. 62/007,149, filed on Jun. 3, 2014.

(51) Int. Cl. G06Q 30/06; G06Q 50/00

(52) U.S. Cl. CPC G06Q 30/0633; G06Q 50/01

(57) ABSTRACT

A method for facilitating electronic commerce social gifting, wherein an initial user can select a specific gift to be given to a gift recipient. A plurality of vendors and a plurality of gifts from which the initial user selects the specific gift are presented to the initial user through an initial user account. The initial user then provides recipient information, gifting medium, and gift acceptance time period. The gifting medium defines the method in which a gift redemption code is sent to the gift recipient (e.g. text message, email, social media website), while the recipient information provides the personal data for sending the gift redemption code through the gifting medium. If the specific gift is not accepted by the gift recipient within the gift acceptance time period, then the gift redemption code is cancelled. If accepted, the specific gift or a gift value can be redeemed by the gift recipient.

The current application claims a priority to the U.S. Provisional Patent application Ser. No. 62/007,149 filed on Jun. 3, 2014.

### FIELD OF THE INVENTION

The present invention relates generally to electronic transactions. More specifically, the present invention is an electronic commerce social gifting system which streamlines the social gifting transactional process for initial users.

### BACKGROUND OF THE INVENTION

It is tradition in many cultures for individuals to exchange gifts amongst each other. Before the birth of the internet, gifts were purchased in a physical store by individuals and then presented to others. Gifts were either given to others in person or shipped via mail services. With the rise in prominence of electronic commerce it has become increasing popular for gifts to be purchased online rather than in a physical store. The gift can either be shipped to the gift giver, wherein the gift giver then presents the gift in person, or the gift can be directly shipped to the gift recipient. As efficient, time saving, and appealing online transactions can be, some problems arise with the way in which online transactions are carried out. For example, the gift giver must provide an address to which the gift must be shipped. If the gift recipient has multiple residencies, then the gift giver may have to guess which residency to deliver the gift, making it more difficult to send a spontaneous or unexpected gift. Additionally, if the gift recipient already owns the gift, it is difficult for the gift recipient to return the gift through the online source without the aid of the gift giver. Overall, electronic commerce gifting is not streamlined and very difficult to transact, deliver, and complete.

Therefore it is the object of the present invention to provide a method for facilitating electronic commerce social gifting that streamlines the overall transactional processes of both the gift giver and gift receiver. The present invention permits the gift giver to select a specific gift from a plurality of gifts and a plurality of vendors. Upon selecting the specific gift, the gift giver also provides the gift recipient, recipient information, a gifting medium, and a gift acceptance time period. A gift redemption code is generated and sent to the gift recipient through the gifting medium using the recipient information. The gifting medium can be a Short Message Communication, electronic mail communication, third party social media web site, or any other electronic means. The gift recipient can then choose to either accept or decline the specific gift sent by the gift giver. If the gift recipient does not accept the gift within the gift acceptance time period, then the transaction is cancelled. If the gift recipient accepts the specific gift, then the gift recipient can redeem either the specific gift itself or a gift value for the specific gift. If the gift value is redeemed, then the gift value can be banked and used at a later time, applied to a different gift, or cashed out.

### BRIEF DESCRIPTION OF THE DRAWINGS

FIG. 1 is a flowchart depicting the method for facilitating electronic commerce social gifting;

FIG. 2 is a flowchart thereof, elaborating on the gift selection process;

FIG. 3 is a flowchart thereof, wherein an initial user provides a gift acceptance time period for accepting a specific gift;

FIG. 4 is a flowchart thereof, wherein a gift redemption code is redeemed for the specific gift;

FIG. 5 is a flowchart thereof, wherein the gift redemption code is redeemed for a gift value of the specific gift, and wherein the gift value is added to a total account value; and

FIG. 6 is a flowchart thereof, wherein the gift redemption code is redeemed for the gift value, and wherein the gift value is used to purchase a subsequent gift.

FIG. 7 is a flowchart of the overall process, wherein an initial user selects a specific gift for a gift recipient, and wherein the gift recipient can either accept or decline the specific gift from the initial user.

### DETAIL DESCRIPTIONS OF THE INVENTION

All illustrations of the drawings are for the purpose of describing selected versions of the present invention and are not intended to limit the scope of the present invention.

The present invention is a method for facilitating electronic commerce social gifting. The present invention aims to streamline the process for purchasing and transferring a gift to an individual through an online medium. The present invention is implemented across a network of computing devices including a back end host and individual electronic devices. The back end host can include a server, multiple servers, etc. and provides the network equipment for supporting a webpage, storing initial user information, and processing gifting orders. The individual electronic devices provide a front end for consumers and allow the consumers to access the webpage in order to send and receive gifts.

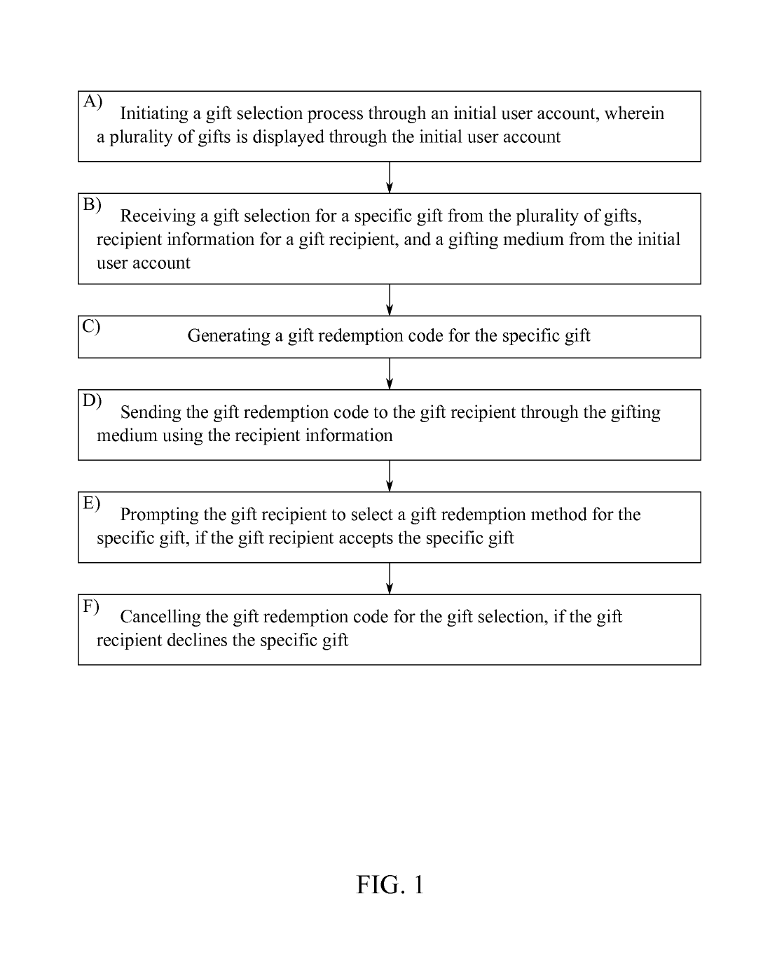

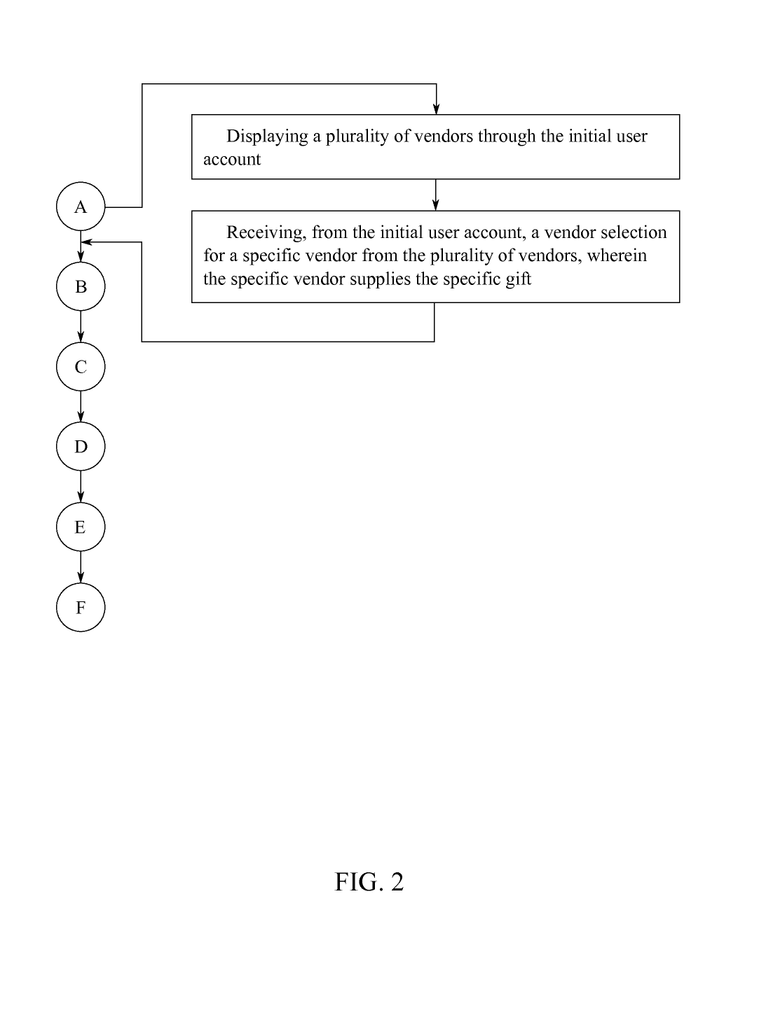

In reference to FIG. 1-2, an initial user can choose a specific gift 31 from a plurality of gifts 3 to give to a gift recipient through the webpage, wherein the plurality of gifts 3 is displayed in conjunction with a plurality of vendors 4. In order to gift an item to someone, the initial user must first create an initial user account 1. The creation of the initial user account 1 may include the collection of personal information including, but not limited to, an email address, password, name, initial username, address, phone number, or billing information. Upon creating the initial user account 1, the initial user can then freely log in and out of the initial user account 1 using provided identification credentials, such as the initial username and password provided in the personal information or any other suitable identification credentials.

Upon logging into the initial user account 1, the initial user can access the plurality of vendors 4 and the plurality of gifts 3 that are displayed through the initial user account 1. The webpage can be configured in several layouts in order to present the plurality of vendors 4 and the plurality of gifts 3 to the initial user. For example, the webpage may be designed such that the initial user first accesses a vendor page, wherein the initial user picks a selected vendor from the plurality of vendors 4 displayed through the initial user account 1. The initial user is then displayed each of the plurality of gifts 3 that is provided by the selected vendor, wherein the initial user can choose the specific gift 31 from the plurality of gifts 3 provided by the selected vendor.

In an alternative embodiment, the webpage may be designed such that the initial user first accesses a gift page, wherein the initial user picks the specific gift 31 from the plurality of gifts 3 displayed through the initial user account 1. The initial user is then displayed the plurality of vendors 4 that provide the specific gift 31, wherein the initial user can choose the selected vendor from the plurality of vendors 4 that provides the specific gift 31. It is also possible for the plurality of gifts 3 to be displayed and accessed in any other format. For example, categories and sub-categories can be implemented in order to further organize the plurality of gifts 3.

In the preferred embodiment of the present invention, the initial user account 1 is charged for the cost of the specific gift 31 when the initial user selects the specific gift 31. The initial user account 1 is charged for the specific gift 31 using the billing information provided by the initial user. In an alternative embodiment of the present invention, the initial user account 1 is charged for the cost of the specific gift 31 only if the gift recipient accepts the specific gift 31 from the initial user. The initial user account 1 is then charged for the specific gift 31 at the time of acceptance using the billing information provided by the initial user. If the specific gift 31 is not accepted by the gift recipient, then the initial user account 1 is not billed or charged for the specific gift 31.

In order for the gift recipient to accept and collect the specific gift 31 that has been gifted by the initial user, the gift recipient must have a subsequent user account 2. Similar to the initial user account 1 for the initial user giving the specific gift 31, creation of the subsequent user account 2 may include the collection of personal information for the gift recipient including, but not limited to, an email address, password, name, initial username, address, phone number, or billing information. Upon creating the subsequent user account 2, the gift recipient can then freely log in and out of the subsequent user account 2 using the provided identification credentials of the gift recipient, such as the initial username and password provided in the personal information of the gift recipient or any other suitable identification credentials. The gift recipient can then accept and collect subsequent gifts through the subsequent user account 2, as well as send gifts to other individuals.

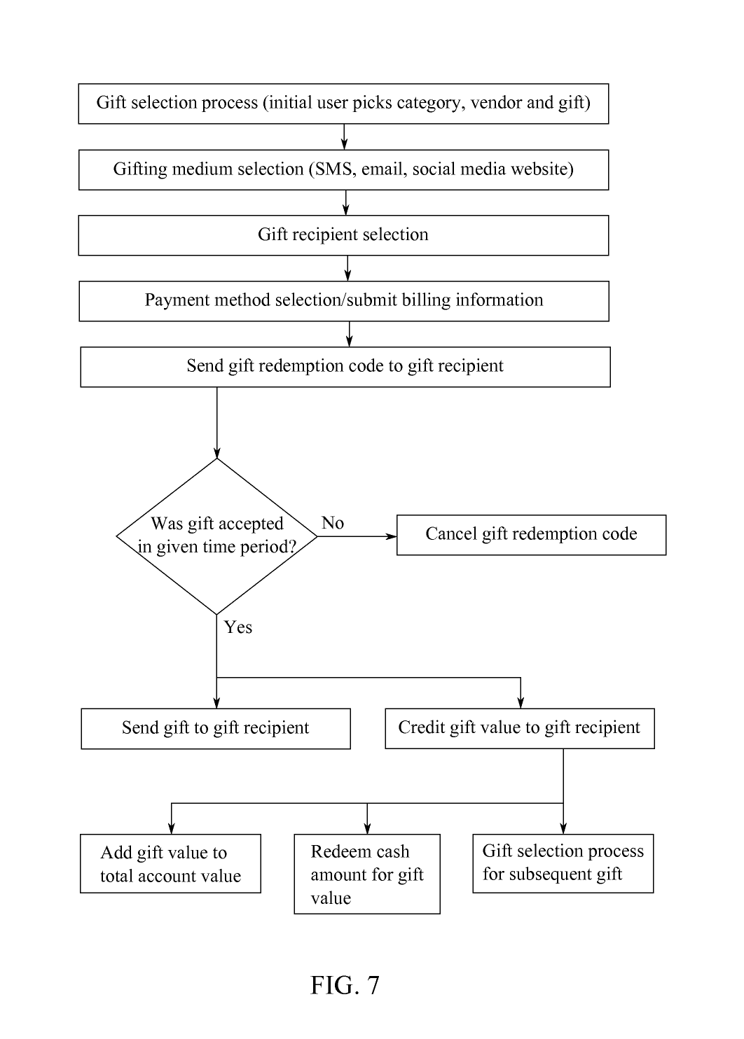

In reference to FIG. 1, when the initial user chooses the specific gift 31 and the gift recipient, the initial user also provides recipient information 5 and selects a gifting medium 60 through which a gift redemption code 62 is delivered to the gift recipient. The gift redemption code 62 is associated with both the specific gift 31 and the initial user account 1. If the specific gift 31 is accepted by the gift recipient and the initial user account 1 has not yet been charged for the specific gift 31, then the billing information for the initial user is retrieved and utilized to process the purchase of the specific gift 31 for the gift recipient. The gifting medium 60 defines the means through which the gift redemption code 62 is delivered to the gift recipient. For example, the gifting medium 60 can be a Short Message Service (SMS) communication, an electronic mail communication, a third party social media website, or the network on which the present invention is operated, as depicted in FIG. 7.

The recipient information 5 provides personal information of the gift recipient that is required for delivering the gift redemption code 62 to the gift recipient through the gifting medium 60. For example, if the gifting medium 60 is the SMS communication, then the recipient information 5 would include the phone number of the gift recipient. If the gifting medium 60 is the electronic mail communication, then the recipient information 5 would include the email address of the gift recipient. If the gifting medium 60 is the third party social media website, then the recipient information 5 would include the initial username or required profile information of the gift recipient. If the gifting medium 60 is the network on which the present invention is operated, then the recipient information 5 would include the initial username of the subsequent user account 2 of the gift recipient.

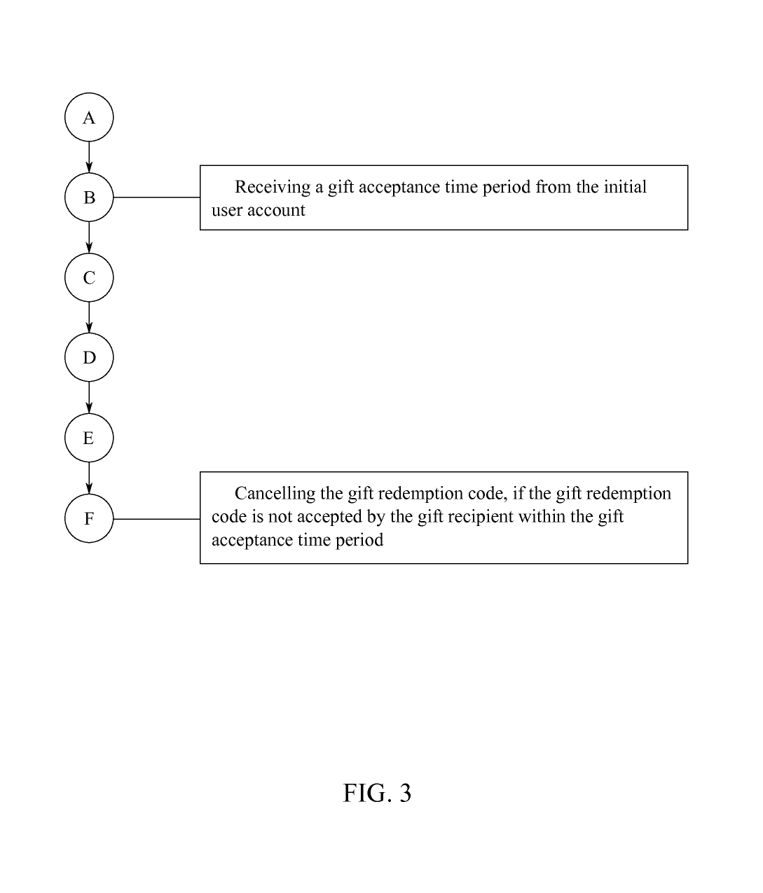

In reference to FIG. 3, the initial user may also designate a gift acceptance time period 61 when choosing the specific gift 31. The gift acceptance time period 61 defines the amount of time the gift recipient has to log into the subsequent user account 2 and accept the gift redemption code 62; either by clicking an accept button or redeeming the gift redemption code 62 for the specific gift 31. If the gift redemption code 62 is not accepted by the gift recipient within the gift acceptance timer period, then the gift redemption code 62 is cancelled and the initial user account 1 is credited for the value of the specific gift 31 minus any applicable fees, if any. The initial user can then cash out for the value of the specific gift 31 or apply the value of the specific gift 31 to the purchase of another gift. If the initial user has not already paid for the specific gift 31 at the time the redemption code 62 is cancelled, then the initial user account 1 is not billed for the purchase of the specific gift 31. The gift acceptance time period 61 can be entered as a number of days, weeks, months, years, etc., or as a specific date on which the gift redemption code 62 expires, depending on the configuration of the webpage. For example, if the initial user purchases the specific gift 31 on the first day of the month, then the gift acceptance time period 61 could be entered as one week, or the seventh of the month (given that the gift acceptance time period 61 begins the day the specific gift 31 is purchased).

It may be another function of the invention to provide the ability to delay the delivery of the gift redemption code 62 from the day the specific gift 31 is purchased. For example, if the initial user wishes to have the gift redemption code 62 delivered on a specific day, such as a birthday or holiday, the specific gift 31 may be purchased in advance and a delivery date can be set on which the gift redemption code 62 will be sent to the gift recipient. If the option to use the delivery date is selected by the initial user, then the gift acceptance time period 61 begins from the delivery date.

In reference to FIG. 7, when the gift recipient receives the gift redemption code 62, the gift recipient can choose to either accept or decline the specific gift 31. The gift recipient accepts the specific gift 31 by logging into the subsequent user account 2 and either clicking the accept button or redeeming the gift redemption code 62 for the specific gift 31 as previously stated, or declines the specific gift 31 by clicking a decline button. The gift recipient can also choose to take no action, wherein the gift redemption code 62 is cancelled after the gift acceptance time period 61 has surpassed. If the specific gift 31 is declined by the gift recipient in either way, the gift redemption code 62 is cancelled and the initial user who purchased the specific gift 31 is credited for the value of the specific gift 31 minus any applicable fees, if any. If the initial user has not already paid for the specific gift 31 at the time the redemption code 62 is cancelled, then the initial user account 1 is not billed or charged for the purchase of the specific gift 31.

In further reference to FIG. 7, if the gift recipient accepts the specific gift 31, then the gift recipient is prompted to select a gift redemption method for the specific gift 31. The gift redemption method defines the way in which the specific gift 31 is redeemed or received by the gift recipient. One option allows the gift recipient to receive the specific gift 31, wherein the gift recipient provides shipping information 64 for where to deliver the specific gift 31. The shipping information 64 may include, but is not limited to, an address, shipping service, shipping date, and speed of shipping. If the gift recipient would like to give the gift to someone else, then the gift recipient could provide the shipping information 64 for another individual. Additionally, the specific gift 31 can be redeemed at a physical location when applicable, such as at a restaurant, bar, sporting event, concert, etc. For example, if the specific gift 31 is a/are gift card(s), ticket(s), product(s), service(s), or rental(s), then a notification can be sent directly to the venue along with personal information of the gift recipient that is used to verify the identity of the gift recipient upon redeeming the specific gift 31 at the venue. Alternatively, a code for the gift card(s), ticket(s), product(s), service(s), or rental(s) can be sent to the gift recipient (via email, text message, etc.), wherein the gift recipient can redeem the specific gift 31 at the venue. Another option allows the gift recipient to redeem the value of the specific gift 31 as opposed to the specific gift 31 itself. In such a case, a gift value 32 is determined for the specific gift 31 and credited to the subsequent user account 2. The gift value 32 is most likely the original purchase price of the specific gift 31 unless service charges or other fees are applied.

If the gift recipient chooses to redeem the gift redemption code 62 for the gift value 32, then the gift value 32 can be applied in one of two ways. The first option is for the gift value 32 to be added to a total account value 20 for the gift recipient, wherein the total account value 20 is stored under the subsequent user account 2. In this way, the gift recipient can either add to the total account value 20 in order to purchase a different gift, either for themselves or for another individual, or the gift recipient can cash out. The gift recipient can cash out for the gift value 32 or collect the gift value 32 for multiple gifts and cash out for the total account value 20. The other option is for the gift value 32 to be directly applied to the purchase of a different gift to be sent to either the gift recipient or another individual selected by the gift recipient.

The following is provided to show an example flow of the communications carried out between the back end host and both a first electronic device of the initial user and a second electronic device of the gift recipient. The initial user logs in to the initial user account 1 through the first electronic device, wherein the identification credentials of the initial user, such as the username and password of the initial user, is sent to the back end host. The back end host verifies the identification credentials provided by the initial user and permits access to the initial user account 1 if the identification credentials of the initial user are successfully authenticated. In reference to FIG. 1, once logged in, the initial user can initiate a gift selection process, wherein the plurality of gifts 3 is displayed to the initial user on the first electronic device through the initial user account 1.

The gift selection process is dictated by the layout and configuration of the webpage, wherein the initial user is first presented with either the plurality of vendors 4 or the plurality of gifts 3. If the plurality of vendors 4 is displayed first, then the initial user makes a vendor selection 40 for a specific vendor 41 from the plurality of vendors 4 through the webpage on the first electronic device. The vendor selection 40 is received by the back end host, wherein each of the plurality of gifts 3 provided by the specific vendor 41 is displayed to the initial user on the first electronic device. The initial user then makes a gift selection 30 for a specific gift 31 from the plurality of gifts 3 provided by the specific vendor 41 through the webpage on the first electronic device. The gift selection 30 is then received by the back end, wherein the initial user is then prompted to provide the gift recipient, the recipient information 5, the gifting medium 60, and the gift acceptance time period 61. Additionally, the initial user is prompted to select a payment method using the billing information provided under the initial user account 1.

If the plurality of gifts 3 is displayed first, then the initial user makes the gift selection 30 for the specific gift 31 from the plurality of gifts 3 through the webpage on the first electronic device. The gift selection 30 is received by the back end host, wherein each of the plurality of vendors 4 that provides the specific gift 31 is displayed to the initial user on the first electronic device. The initial user then makes the vendor selection 40 for the specific vendor 41 from the plurality of vendors 4 that provides the specific gift 31 through the webpage on the first electronic device. The vendor selection 40 is then received by the back end, wherein the initial user is then prompted to provide the gift recipient, the recipient information 5, the gifting medium 60, and the gift acceptance time period 61. Additionally, the initial user is prompted to select a payment method using the billing information provided under the initial user account 1.

In reference to FIG. 1 and FIG. 3, once the gift selection 30 process has been completed by the initial user, the initial user submits the gift recipient, the recipient information 5, the gifting medium 60, the gift acceptance time period 61, and the payment method through the first electronic device. The gift recipient, the recipient information 5, the gifting medium 60, the gift acceptance time period 61, and the payment method are received by the back end host, wherein the provided information is utilized to process the gift transaction. The back end host generates the gift redemption code 62 for the specific gift 31 and sets the gift acceptance time period 61 after which the gift redemption code 62 will expire. Using the recipient information 5, the back end host then sends the gift redemption code 62 to the gift recipient through the gifting medium 60 (e.g. SMS communication, electronic mail communication, third party social media website). Additionally, the initial user account 1 is then billed or charged for the cost of the specific gift 31 using the payment method selected by the initial user.

Once the gift recipient receives the gift redemption code 62, the gift recipient can accept or decline the specific gift 31. If the gift recipient declines the specific gift 31 or the gift acceptance time period 61 expires, wherein the back end host does not receive a response, then the back end host cancels the gift redemption code 62 as depicted in FIG. 1 and FIG. 3, and credits the initial user account 1 for the purchase of the specific gift 31. In order to accept the specific gift 31, the gift recipient must log in to the subsequent user account 2 on the second electronic device. Once logged in to the subsequent user account 2 on the second electronic device, the gift recipient can accept the specific gift 31, wherein a gift acceptance notification 63 is sent to the back end host. Upon receiving the gift acceptance notification 63 from the subsequent user account 2, the back end host prompts the gift recipient to select the gift redemption method for the specific gift 31.

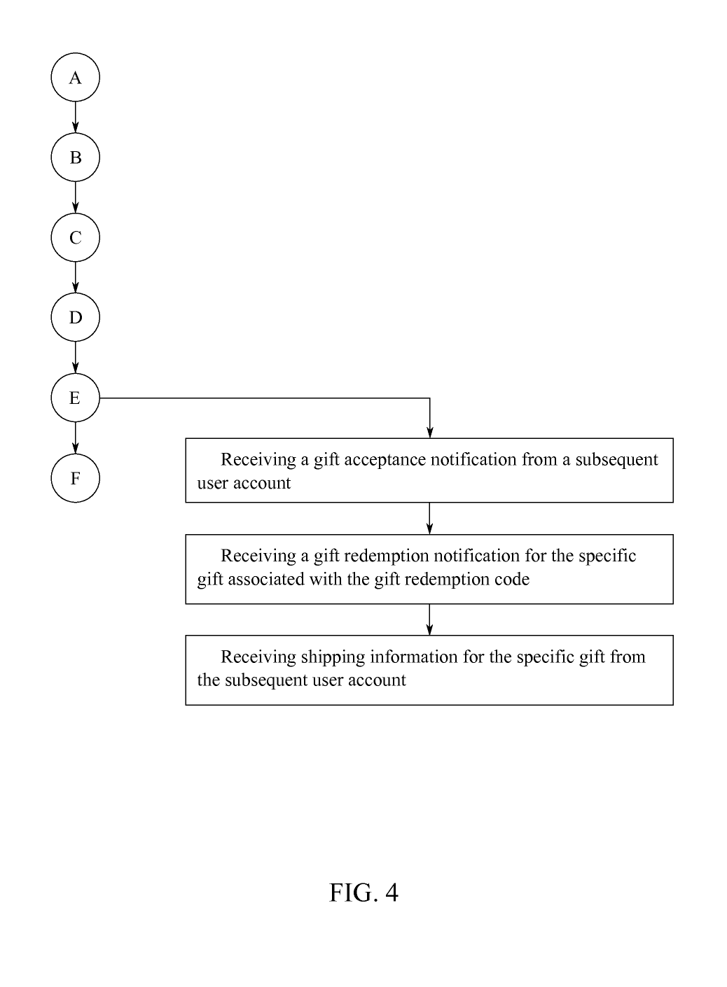

When the gift recipient is prompted to provide the gift redemption method, the gift recipient can choose to either redeem the specific gift 31 or the gift value 32 of the specific gift 31. In reference to FIG. 4, if the gift recipient chooses to redeem the specific gift 31, then a gift redemption notification is sent from the second electronic device through the subsequent user account 2 to the back end host. The back end host then receives the gift redemption notification and prompts the gift recipient to provide the shipping information 64 to deliver the specific gift 31. The gift recipient then submits the shipping information 64 through the subsequent user account 2, wherein the shipping information 64 is received by the back end host and processed to deliver the specific gift 31 to the gift recipient. Alternatively, if the specific gift 31 is a gift card or tickets to a venue, then a notification can be sent directly to the venue along with personal information of the gift recipient that is used to verify the identity of the gift recipient upon redeeming the specific gift 31 at the venue. A code for the gift card(s), ticket(s), product(s), service(s), or rental(s) can also be sent to the gift recipient (via email, text message, etc.), wherein the gift recipient can redeem the specific gift 31 at the venue.

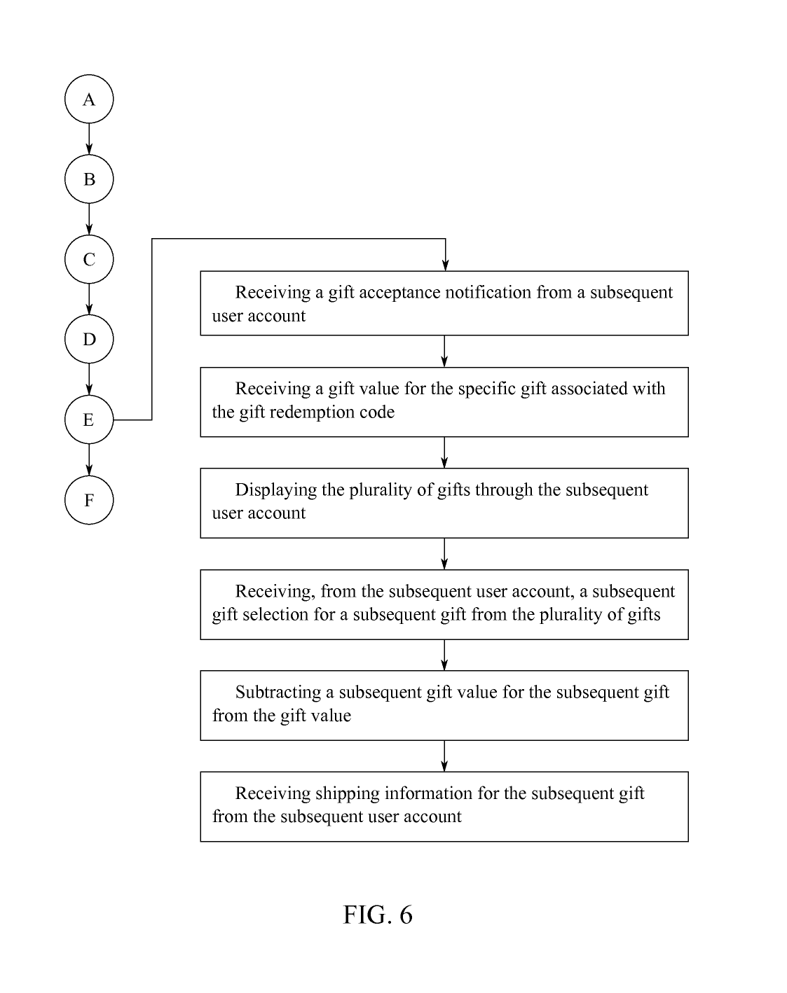

In reference to FIG. 6, if the gift recipient chooses to redeem the gift value 32 of the specific gift 31, then the gift value 32 for the specific gift 31 is retrieved by the back end host. The gift value 32 can then be used by the gift recipient to purchase a subsequent gift 34 from the plurality of gifts 3. In this case the plurality of gifts 3 and the plurality of vendors 4 is displayed to the gift recipient on the second electronic device through the subsequent user account 2. The back end host then receives a subsequent vendor selection 42 for a subsequent vendor 43 from the plurality of vendors 4 along with a subsequent gift selection 33 for the subsequent gift 34.

In further reference to FIG. 6, upon receiving the subsequent gift selection 33, the back end host retrieves a subsequent gift value 35 for the subsequent gift 34. The back end host then subtracts the subsequent gift value 35 from the gift value 32. If the gift value 32 is larger than the subsequent gift value 35, then the remaining balance is credited to the total account value 20 of the subsequent user account 2. If the subsequent gift value 35 is larger than the gift value 32, then the gift recipient is prompted to provide billing information in order to pay for the remaining balance. Once the remaining balance has been appropriately handled, the back end prompts the gift recipient to provide the shipping information 64 to deliver the subsequent gift 34. The gift recipient then submits the shipping information 64 for the subsequent gift 34 through the subsequent user account 2, wherein the shipping information 64 for the subsequent gift 34 is received by the back end host and processed to deliver the subsequent gift 34 to the gift recipient. Alternatively, for gift card(s), ticket(s), product(s), service(s), or rental(s) a notification can be sent directly to a venue or a code can be electronically sent to the gift recipient to redeem the specific gift 31 at the venue.

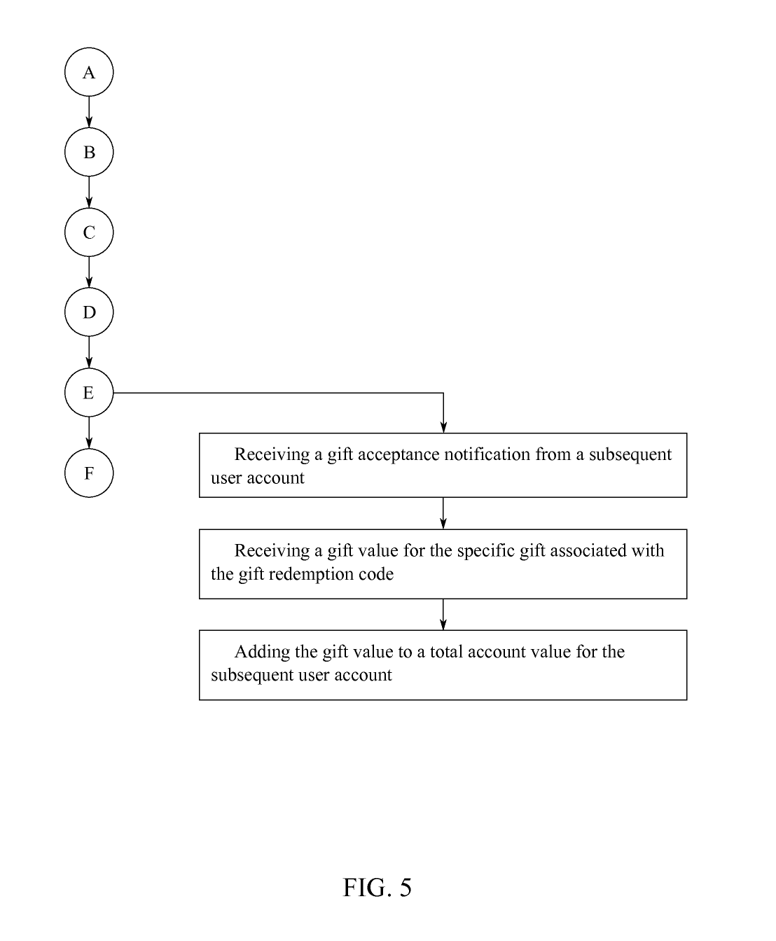

In reference to FIG. 5, the gift value 32 can also be directly credited to the total account value 20 of the subsequent user account 2. In this way, the gift recipient can collect the gift value 32 from multiple gifts over a period of time in order to increase the total account value 20. The total account value 20 can then be used to purchase a more expensive gift or multiple other gifts. Additionally, the gift recipient can choose to cash out, wherein the gift recipient receives the total account value 20 as a check or other money form, such as a direct deposit. The back end host collects the necessary payout information, such as a name, address, account information, etc., and then processes the transaction for the payout of the total account value 20.

Although the invention has been explained in relation to its preferred embodiment, it is to be understood that many other possible modifications and variations can be made without departing from the spirit and scope of the invention as hereinafter claimed.

What is claimed is:

1. A method for electronic commerce social gifting by executing computer-executable instructions stored on a non-transitory computer-readable medium, the method comprises the steps of:
initiating a gift selection process through an initial user account, wherein a plurality of gifts is displayed through the initial user account;
receiving a gift selection for a specific gift from the plurality of gifts, recipient information for a gift recipient, and a gifting medium from the initial user account;
generating a gift redemption code for the specific gift;
sending the gift redemption code to the gift recipient through the gifting medium using the recipient information;
prompting the gift recipient to select a gift redemption method for the specific gift,
if the gift recipient accepts the specific gift; and
cancelling the gift redemption code for the gift selection,
if the gift recipient declines the specific gift.

2. The method for electronic commerce social gifting by executing computer-executable instructions stored on a non-transitory computer-readable medium, the method as claimed in claim 1, wherein the gifting medium is a Short Message Service communication.

3. The method for electronic commerce social gifting by executing computer-executable instructions stored on a non-transitory computer-readable medium, the method as claimed in claim 1, wherein the gifting medium is an electronic mail communication.

4. The method for electronic commerce social gifting by executing computer-executable instructions stored on a non-transitory computer-readable medium, the method as claimed in claim 1, wherein the gifting medium is a third party social media website.

5. The method for electronic commerce social gifting by executing computer-executable instructions stored on a non-transitory computer-readable medium, the method as claimed in claim 1 further comprises the steps of:
displaying a plurality of vendors through the initial user account; and
receiving, from the initial user account, a vendor selection for a specific vendor from the plurality of vendors, wherein the specific vendor supplies the specific gift.

6. The method for electronic commerce social gifting by executing computer-executable instructions stored on a non-transitory computer-readable medium, the method as claimed in claim 1 further comprises the steps of:
receiving a gift acceptance notification from a subsequent user account; and
receiving a gift redemption notification for the specific gift associated with the gift redemption code.

7. The method for electronic commerce social gifting by executing computer-executable instructions stored on a non-transitory computer-readable medium, the method as claimed in claim 6 further comprises the steps of:
receiving shipping information for the specific gift from the subsequent user account.

8. The method for electronic commerce social gifting by executing computer-executable instructions stored on a non-transitory computer-readable medium, the method as claimed in claim 1 further comprises the steps of:
receiving a gift acceptance notification from a subsequent user account; and
retrieving a gift value for the specific gift associated with the gift redemption code.

9. The method for electronic commerce social gifting by executing computer-executable instructions stored on a non-transitory computer-readable medium, the method as claimed in claim 8 further comprises the steps of:
adding the gift value to a total account value for the subsequent user account.

10. The method for electronic commerce social gifting by executing computer-executable instructions stored on a non-transitory computer-readable medium, the method as claimed in claim 8 further comprises the steps of:
displaying the plurality of gifts through the subsequent user account;
receiving, from the subsequent user account, a subsequent gift selection for a subsequent gift from the plurality of gifts; and
subtracting a subsequent gift value for the subsequent gift from the gift value.

11. The method for electronic commerce social gifting by executing computer-executable instructions stored on a non-transitory computer-readable medium, the method as claimed in claim 10 further comprises the steps of:
receiving shipping information for the subsequent gift from the subsequent user account.

12. The method for electronic commerce social gifting by executing computer-executable instructions stored on a non-transitory computer-readable medium, the method as claimed in claim 1 further comprises the steps of:
receiving a gift acceptance time period from the initial user account; and
cancelling the gift redemption code,
if the gift redemption code is not accepted by the gift recipient within the gift acceptance time period.

13. A method for electronic commerce social gifting by executing computer-executable instructions stored on a non-transitory computer-readable medium, the method comprises the steps of:
initiating a gift selection process through an initial user account, wherein a plurality of gifts and a plurality of vendors are displayed through the initial user account;
receiving, from the initial user account, a vendor selection for a specific vendor from the plurality of vendors and a gift selection for a specific gift from the plurality of gifts, wherein the specific vendor supplies the specific gift;
receiving recipient information for a gift recipient, a gifting medium, and a gift acceptance time period from the initial user account;
generating a gift redemption code for the specific gift;
sending the gift redemption code to the gift recipient through the gifting medium using the recipient information;
receiving a gift acceptance notification and a gift redemption method from a subsequent user account,
if the gift recipient accepts the specific gift, wherein the gift redemption method includes either receiving a gift redemption notification or retrieving a gift value for the specific gift associated with the gift redemption code; and
cancelling the gift redemption code for the gift selection,
if the gift redemption code is not accepted by the gift recipient within the gift acceptance time period.

14. The method for electronic commerce social gifting by executing computer-executable instructions stored on a non-transitory computer-readable medium, the method as claimed in claim 13, wherein the gifting medium is a Short Message Service communication.

15. The method for electronic commerce social gifting by executing computer-executable instructions stored on a non-transitory computer-readable medium, the method as claimed in claim 13, wherein the gifting medium is an electronic mail communication.

16. The method for electronic commerce social gifting by executing computer-executable instructions stored on a non-transitory computer-readable medium, the method as claimed in claim 13, wherein the gifting medium is a third party social media website.

17. The method for electronic commerce social gifting by executing computer-executable instructions stored on a non-transitory computer-readable medium, the method as claimed in claim 13 further comprises the steps of:
receiving shipping information for the specific gift from the subsequent user account.

18. The method for electronic commerce social gifting by executing computer-executable instructions stored on a non-transitory computer-readable medium, the method as claimed in claim 13 further comprises the steps of:
adding the gift value to a total account value for the subsequent user account.

19. The method for electronic commerce social gifting by executing computer-executable instructions stored on a non-transitory computer-readable medium, the method as claimed in claim 13 further comprises the steps of:
displaying the plurality of gifts through the subsequent user account;
receiving a subsequent gift selection for a subsequent gift from the plurality of gifts; and
subtracting a subsequent gift value for the subsequent gift from the gift value.

20. The method for electronic commerce social gifting by executing computer-executable instructions stored on a non-transitory computer-readable medium, the method as claimed in claim 19 further comprises the steps of:
receiving shipping information for the subsequent gift from the subsequent user account.
